(19) United States
(12) Patent Application Publication
(10) Pub. No.: US 2006/0281557 A1
(43) Pub. Date: Dec. 14, 2006

(54) Collectable game cartridges and methods of using collectable game cartridges

(76) Inventor: Kevin B. Ray, Oakland, CA (US)

Correspondence Address: DOV ROSENFELD, 5507 COLLEGE AVE, SUITE 2, OAKLAND, CA, 94618, US

(21) Appl. No.: 11/148,517

(22) Filed: Jun. 9, 2005

(51) Int. Cl. A63F 13/00

(52) U.S. Cl. 463/44

(57) ABSTRACT

A game cartridge is described that retains a player's current holdings related to game play in a write-once memory. The cartridge thus becomes closely identified with the previous play of a player to simulate non-electronic collectable card or other status games. Further, some aspects of the invention allow for initialization of the player's holdings. In one embodiment of the present invention, the game cartridge provides an environment for playing a collectable card game, such as a POKÉMON™-type game, and the game cartridge remembers and can update the current holdings of electronic cards. The game cartridges of the present invention are collectable items in that they retain a current accounting of a player's holdings and can be traded among different players.

### BACKGROUND

The present invention generally relates to apparatus and methods for computer games, and more particularly to a programmable game cartridge and methods of playing games and of using field-programmable game cartridges.

Portable electronic game systems provide a player with a rich gaming environment. Systems such as the NINTENTDO GAME BOY™, for example, include a game machine that can accept one of a plurality of different game cartridges. A game machine is operated by a player and typically includes: input devices, such as buttons and/or a joy stick; output devices, such as one or more display screens, speakers, display lamps, and so forth; and mechanical and/or electrical connectors to accept cartridges or CDs. The cartridge includes a computer program for the game machine to play the game, including accepting input and providing output to the player for playing a specific game.

One example of a prior art game system 100 is shown in FIGS. 1-2, where FIG. 1 is a front perspective view of a game machine 110, and FIG. 2 is a rear perspective view of the game machine and a prior art game cartridge 120, shown removed from the game machine. Game machine 110 has a top half 111 and a bottom half 113 connected by a hinge 115, permitting the game machine to be arranged in an open configuration, as shown in FIG. 1, or in a closed configuration, as shown in FIG. 2. Game machine 110 presents a variety of user inputs and outputs for a player including control buttons 117a, 117b, a touch screen display 119a, another display 119b, and speakers 118. Game cartridge 120 has a connector 122, while game machine 110 has a matching connector 112 for mating with connector 122 to electrically connect the game cartridge 120 with game machine 110. Game cartridge 120 includes a computer program to provide a player the mechanism to play one or more games on system 100 when the game cartridge is connected to game machine 110, as indicated by arrow A. System 100 can either be a stand-alone system, or can include cables or a transmitter/receiver to communicate with other systems for multi-player gaming.

Note that while in general, a game cartridge such as cartridge 120 is prior art, a cartridge containing a program embodying one or more aspects of the present invention is not prior art.

FIG. 3 shows a simplified block diagram of the system 100. Game machine 110 is shown as having: a central processing unit (CPU) 311 that is coupled to connector 112; a readable and writable random access memory (RAM) 312 for storing data and/or programming for game processing; a display controller circuit 323 connected to a liquid crystal display (LCD) 324, such as displays 119a, 119b (see FIG. 1); switches 326, for example control buttons 117a or 117b (see FIG. 1) that are actuated by a player to control game system 100; and a game interface 325 which may be connected to another connector or radio frequency communications circuitry, not shown, for communicating with other game machines.

Game cartridge 120 includes a non-volatile, read-only memory (ROM) 321 and additional storage by RAM 323 that are both electrically in contact with connector 122. In the embodiment shown, ROM 321 includes a computer program 322 that instructs the CPU 311 to control the playing of a game by one or more players, including aspects of the present invention. Alternative embodiments include part of the program in RAM 323.

In different versions, cartridge 120 may include one or more of the following components, as is well known in the art: a clock circuit (timer), a memory bank switch control circuit, and a communications mechanism such as an infrared transmitter/receiver or a radiofrequency wireless transmitter/receiver.

When connector 122 of cartridge 120 electrically contacts connector 112 of game machine 110 and power is provided to the game system, CPU 311 has access to the program 322 of ROM 321, and to RAM 323, allowing game system 100 to play a game according to the programming of ROM 321. Cartridge 120 stores, for example, information required to play a game on system 100 including, but not limited to a main program, a switch processing program, an object (or character) control program, an image processing program, an audio processing program, and other programs used for game playing. Additionally, some games may include a mechanism for capturing or training game characters. A game cartridge 120 for such a game then includes programs relevant to game functions, including, for example, a capturing program and a training program. By program is meant code to perform the particular functions. No implications should be made as to whether or not each such function corresponds to a separate program.

Many games provide a player with some measure of quality or status that is accumulated as the result of the play of a game and that may affect the outcome of the game or round of play of the game. As used herein, the term “player status,” or simply as “status,” refers to, without limitation, a skill level or holdings that are associated with a player and that are traded as the result of a game outcome. In general, a player status is made up of one or more individual “status states” that are exchanged among players as a result of the rules of a game. As used herein, the term “status game” refers to, without limitation, a game having a status associated with each of one or more players, including both human and computer players. Examples of status games include, but are not limited to, betting games, where the player status is an amount available for betting on a game outcome, and strategy or role-playing games, where the player status is represented in cards, game pieces, figurines, or other items, including but not limited to weapons or magical powers, having some value in the play of the game. The outcome of the game depends on the player status and, in some games, on some element of chance, such as the throw of dice, and also includes a change or exchange of the player status.

Some status games use cards for status states, and are referred to herein, without limitation, as “collectable card games.” Collectable card games include, without limitation, playing card games where the cards are accumulated as the result of play, such as the card game “war,” and role playing or strategy games that use cards, such as POKÉMON™, Magic the Gathering, Yu-Gi-Oh, POKÉMON™, Vs System, Wizards of the Coast, and Dungeons and Dragons. In collectable card games, the status states include, but are not limited to, card value, a specific character or figure, a weapon, and strengths, powers or magic associated with a card, character, figure, or weapon.

Status games also are known that do not normally use cards as status states, but rather that use characters, figures, or some combination thereof. The status states for these games are also, but are not limited to, card value, a specific character or figure, a game piece or figurine, a weapon, and strengths, powers or magic associated with a card, character, figure, game piece or figurine, or weapon. Examples of these games include, but are not limited to, STAR SISTERZ Collectable Charm Game by Hasbro, Inc., and such collectable miniatures games as MLB SportsClix Collectable Miniatures, Mage Knight, MechWarrior, and HeroClix, each by Wizkids, Inc. of Bellevue (Seattle), Wash. In addition, some status games use cards that are not the status states. In poker, for example, the playing cards do not form part of the player status since they are not accumulated as the result of the play. The player status is the amount of money in her possession, and the status state is a minimum bid amount (for example, one dollar). A player having an insufficient amount of money (status) may not be able to bet enough to play her cards.

Prior art electronic game systems are not capable of simulating many aspects of non-electronic versions of status games. For example, electronic games do not simulate the initialization of the game that occurs when a player purchases a set of a random collection of, collectable cards. Also, typical electronic games to not simulate sets of collectable cards that may be traded among players.

There thus is a need for an electronic gaming environment that simulates the playing of collectable card games. For example, there is a need for an electronic game, e.g., in the form of a game cartridge, that provides for randomly assigning status to the purchasing player upon first use of a game cartridge.

### SUMMARY

Aspects of the present invention provide a game cartridge that is associated with a player status—that is, the player status is stored by a game system in a write-once memory. As used herein, the term “write-once memory,” is a broad and generic term and is used in its ordinary sense and includes, without limitation, to a device, method, or combination thereof that permits information to be stored for later retrieval, but that cannot be erased by the game playing user after it is stored. Write-once memories of the present invention are programmable in the field as the result of use of a game by a player. Examples of a write-once memory include, but are not limited to, a one-time-programmable memory (OTP), a CD-R. Also included are a RAM or a CD-RW or similar normally re-writable device that includes some mechanism, e.g., using encryption, that permits part or all of the memory to be written to using algorithms or devices that do not permit that written memory to be erased or re-written.

One aspect of the invention is providing a game cartridge with a write-once memory. In one embodiment, the game cartridge is used to play a collectable card game including, but not limited to, a POKÉMON™ game, a Magic the Gathering game, a Yu-Gi-Oh game, a Vs System game, a Wizards of the Coast game, or a game played with one or more decks of playing cards. In an alternative embodiment, the game cartridge is used to play a status game that uses characters, figures, game pieces, or some combination thereof as status states.

Another aspect of the invention is providing a write-once memory for a game cartridge for storing player status information related to the playing of an electronic game on a game system. In one embodiment, the player status is initialized by the game system. In another embodiment, the player status is initialized upon first use of the game cartridge.

Yet another aspect of the invention is providing a game cartridge for a game machine. The game cartridge and the game machine form a game system to provide an electronic game, and the electronic game has a player status for the player. The game cartridge comprises a memory to store information related to the player status, wherein the memory is a write-once memory. In one embodiment, the write-once memory is a one-time-programmable memory. In another embodiment, the information related to the player status is initialized by the game system. In yet another embodiment, the game cartridge further includes memory a second memory to store computer-readable code segments to instruct the game system to implement the electronic game.

One aspect of the invention is providing a method of accounting for a player status of a player of an electronic game. The game of the invention is played on a game system including a game cartridge and a game machine. The game cartridge has memory including a write-once memory. The method includes storing data related to a player status in said write-once memory. In one embodiment, the method further includes initializing the player status. In one alternative embodiment, the player status is initialized upon first use of the game cartridge.

Another aspect of the invention is providing a game cartridge including a medium carrying one or more computer readable code segments to instruct a processor to implement a method of accounting for a player status of a player of an electronic game. The game of the invention is played on a game system including a game cartridge and a game machine, and the game cartridge has memory including a write-once memory. The method includes, storing data related to a player status in said write-once memory.

Yet another aspect of the invention is providing a game cartridge including a medium carrying one or more computer readable code segments to instruct a processor to carry out a method of implementing an electronic collectable card game on a game cartridge having a memory. The method includes: presenting a gaming environment to the player for playing the game; reading a player status from a write-once memory of the game cartridge; determining changes in the player status based on the play of the game; and writing changes to the player status to the write-once memory of the game cartridge.

One aspect of the invention is providing a method of trading one or more game cartridges between game cartridge owners, where the trade is based, at least on part, by a status related to the previous playing of each of the traded game cartridges.

These and other aspects and featured will be apparent to those skilled in the art from the description herein, including the drawings, presenting one or more exemplary embodiments, and claims.

### BRIEF DESCRIPTION OF THE DRAWINGS

FIG. 1 shows a front perspective view of an exemplary prior art game machine.

FIG. 2 shows a rear perspective view of the exemplary game machine of FIG. 1 and of a game cartridge.

FIG. 3 shows a simplified block diagram of a prior art game system, such as that shown in FIGS. 1 and 2;

FIG. 4 shows a simplified block diagram of a game cartridge that includes one or more aspects of the present invention, and that may be attached to a prior art game machine.

FIG. 5 shows one embodiment partitioning of a write-once memory of a game cartridge that includes one or more aspects of the present invention.

FIG. 6 is a flow chart of one method embodiment of gaming using a game cartridge that includes one or more aspects of the present invention.

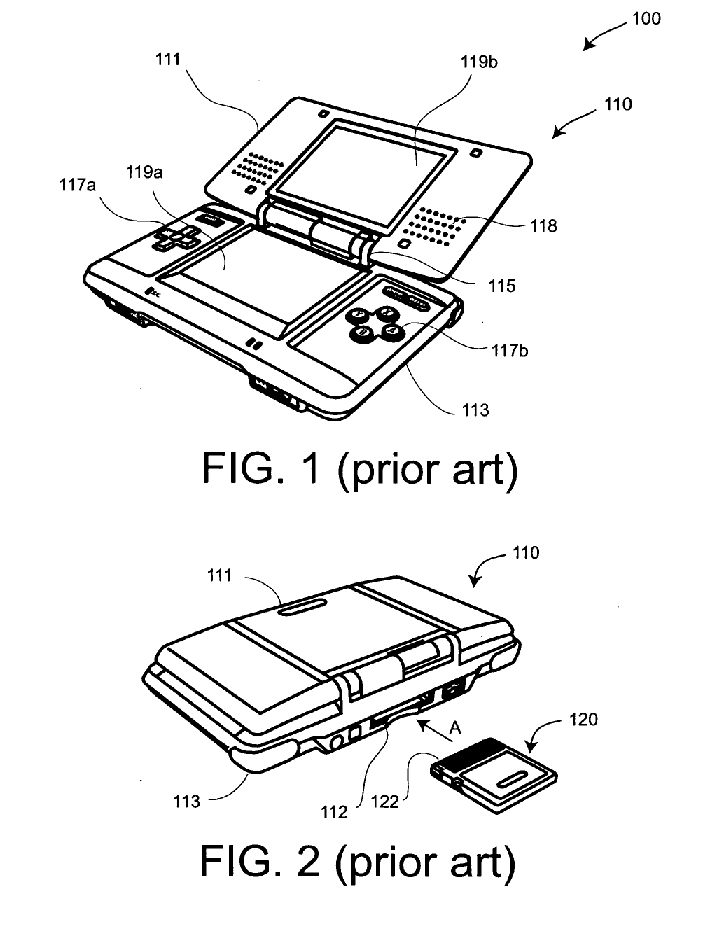

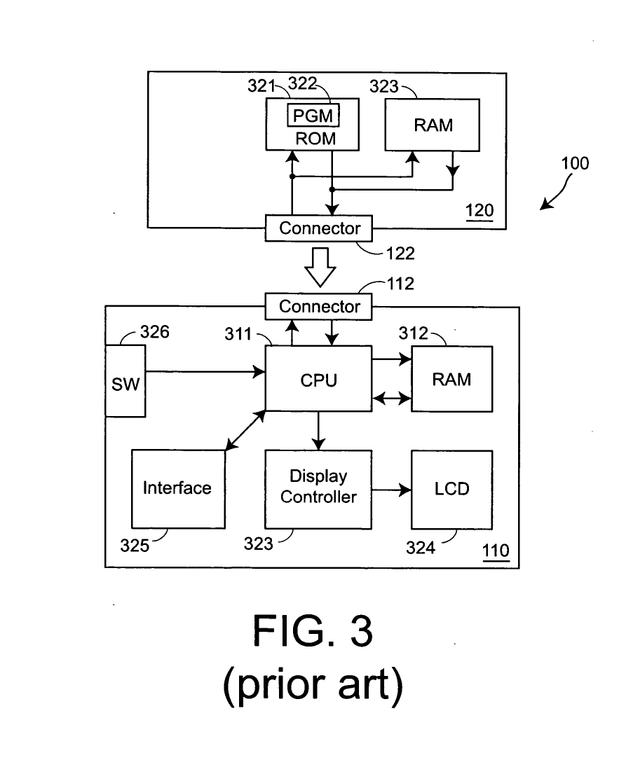

Reference symbols are used in the drawings to indicate certain components, aspects or features shown therein, with reference symbols common to more than one drawing indicating like components, aspects or features shown therein.

### DETAILED DESCRIPTION

Described herein are an inventive game cartridge for playing electronic games, an inventive method of playing games using a game cartridge, and an inventive use for game cartridges.

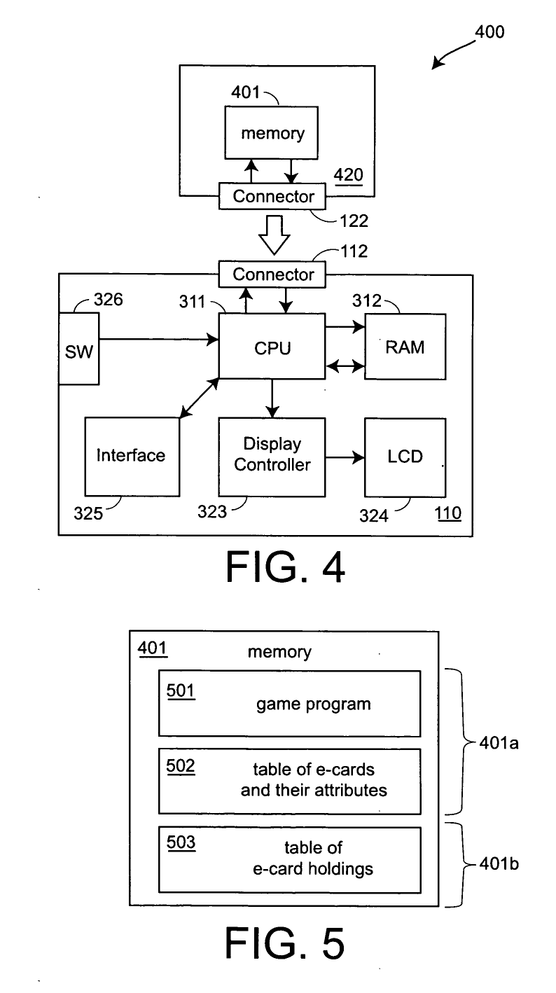

FIG. 4 shows a simplified block diagram of one embodiment of a game cartridge 420 that, when inserted into game machine 110, which can be a prior art game machine, provides an inventive game system 400. Game cartridge 420 includes a memory 401 and connector 122 for electrically connecting the memory 401 to the game machine 110. Game cartridge 420 contains programming that, when coupled to game machine 110, provides an environment for playing a game. Thus, for example, memory 401 includes instructions that are carried out by CPU 311 for playing a game by accepting input through switches 326 or interface 325 and providing output to LCD 324.

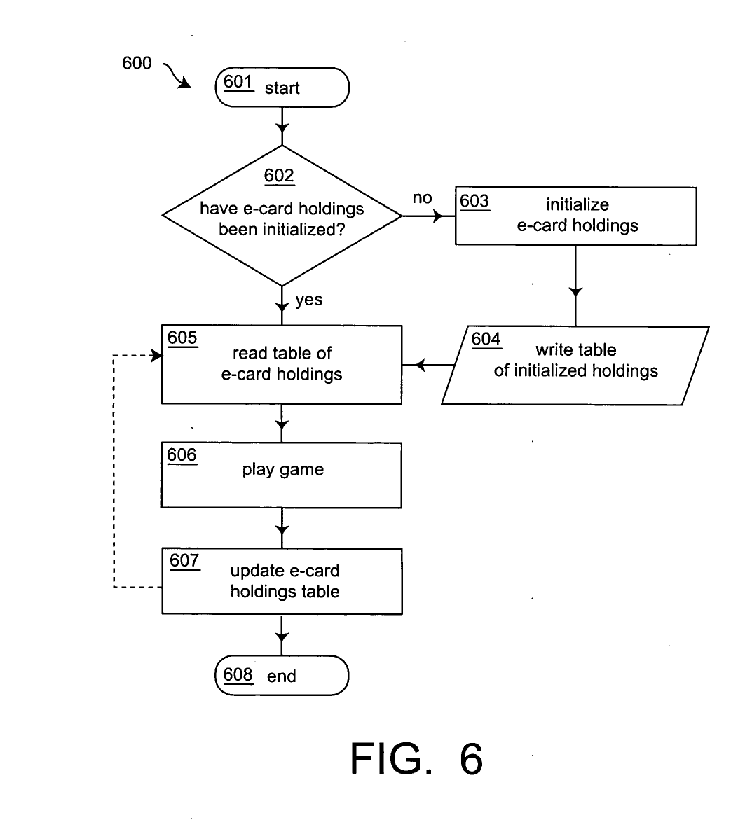

Memory 401 includes a portion with information that is unalterable by game system 400 and a portion that may be altered by the game system. As an example, FIG. 5 shows an embodiment of the memory 401 that includes a first memory 401a that is unalterable by game system 400, and a second memory 401b that is a write-once memory. The embodiment of FIG. 5 is not meant to limit the scope of the invention to a particular type of game or to a specific arrangement of storage of information in memory for a game or type of game. Memory 401a is a ROM that is written during manufacturing of game cartridge 420. Alternatively, memory 401a is a write-once memory that is written to during manufacturing of game cartridge 420 and that is not alterable by game machine 400.

One example of a write-once memory 401b is a One-Time-Programmable memory available under the brand name of MATRIX® 3-D Memory (Matrix Semiconductor, Inc., Santa Clara, Calif.). The MATRIX® 3-D Memory One-Time-Programmable includes a plurality of memory blocks of a fixed size that can each be written to once. One such exemplary memory permits each of 32K blocks of 512 bytes to be written once only.

Embodiments of memory 401 are now described for game cartridge 420 for playing a collectable card game. These embodiments are meant to illustrate the present invention, and are not meant to limit the present invention to a particular game, memory, or data structure. One embodiment of memory 401 includes a game program 501 in the first memory 401a, for example machine instructions for CPU 311 of game system 400 to play a particular collectable card game. First memory 401a also includes a data structure, such as a table 502, of possible status states that are accessible to a player through the game of game program 501. Thus, for example, table 502 includes an indexed listing of e-status and their corresponding attributes, including value, that can be brought into the play of the game. As used herein, the term “e-card” is used, without limitation, to refer to an electronic version of a player's status. Thus the e-card is an electronic version of a collectable card for a collectable card game. Alternatively, an e-card is an electronic representation of any other form of a player status including, but not limited to, money, a game piece, or attributes.

The second memory 401b contains data 503 relating to the current player status for a player. Data 503 includes, but is not limited to the current values, the past values, and initial value of a player status. In one embodiment, data 503 contains a sequence of changes in the player's holdings with reference to the index of the table 502. Table 502 contains an indexed list of e-cards and one or more corresponding attributes that for each e-card. The attributes are configured to be recognizable by the game of a game system 400 according to game program 501. The data 503 corresponds to the current player, and in one embodiment, such data 503 includes an updatable list of indices of e-cards currently held by the player.

As a game is played, data is written sequentially into data 503 as the game progresses. Specifically, sequential writings to data 503 include changes in the player's e-card holdings from a previous play such that the second memory 401b, that, when read from beginning to end, provide an indication of the player's holdings at the current stage of the game being played.

In a preferred embodiment, table 502 contains a listing of each e-card recognized by the game contained in game program 501 of game system 400. As the game proceeds, the game program 501 causes the processor of the game machine to write or modify in data 503 an indication of the most recent change of the current player's holding of e-cards of table 502.

Since second memory 401b is a write-once memory, it contains only a limited amount of memory for storing player status. The player status is initialized in memory 401b during manufacturing of game cartridge 420, or, in an alternate embodiment, at some point during use of the cartridge, such as upon first play of the game of the cartridge 420. The write-once memory of the second memory 401b can be written to only once, and the limited capacity enables the write-once memory to only retain limited information on a player's holdings. The limited amount of write once memory capacity results in a collectable aspect to game cartridge 420 that is not present in prior art game cartridges.

With reference to FIG. 5, when playing a game contained in game cartridge 420, game program 501 has access to table 502 and data 503. Table 502 is preferably an indexed table of possible status states, and data 503 is preferably a table of sequential changes as a result of game play. Game program 501 reads the information contained in data 503 and establishes the player's current status according to table 502. In one embodiment, at the end of each round of play, game program 501 writes data 503 as changes to the status as an index of a status state and a flag to indicate whether the status has been gained (activating the state) or lost (deactivating the state). At an appropriate time the game program 501 reads all of the data 503 to reconstruct the player's current status according to the indexed states in table 502.

The attributes of e-cards are game-dependent. In one embodiment of the present invention, the electronic game is a version of the card game “war” played with one or more decks of playing cards. Table 502 contains an indexed table listing card of one deck of playing cards, with an index from 1 to 52 and a unique card from a standard 52 card deck corresponding to each index. Thus, for example, index 1 corresponds to the ace of spades, index 2 corresponds to the 2 of spades, and so on for each playing card. Data 503 is a sequence of data that, when read, provides the game with the index numbers of the player's holdings according to table 502. In one embodiment of the present invention, game machine 400 writes an indication of the index of each playing card that is lost or gained during a play by “activating” or “deactivating” the e-card, respectively. Thus, for example, data 503 may include one or more indices and a flag that indicates if the status of table 502 corresponding to the indices has been gained or lost during a round of play—that is whether the a particular status state is activated or deactivated, respectively. When all of the data 503 is read according to game program 501, the game program can establish the current state of the player status.

In another embodiment of the present invention, the game is a POKÉMON™ game. Table 502 contains an indexed list of a plurality of POKÉMON™ e-cards that contains each card's attributes. Thus, for example, an index may run from 1 to some large number of cards, which can be from hundreds to thousand of cards, were the attributes are a character, a type of card, a rarity, an energy type, a weakness, and abilities for fighting. The information related to the player's current status 503 contains data that, when read, provides the game with the index numbers of the player's holdings according to table 502. In one embodiment of the present invention, game machine 400 writes an indication of the index of each playing card that is lost or gained during a play by “activating” or “deactivating” the e-card, respectively.

An example of table 502 and data 503 for an electronic version of the card game “war” as played with one deck of 52 playing cards is shown in Tables 1 and 2, respectively. Table 1 contains an index list of each status state, that is, each playing card. The ellipsis between the rows of index 3 and index 52 indicate sequential indices from 4 to 51 and the corresponding playing card, Table 2 contains 1000 updatable memory locations that each hold and index and an indication of the change in status. The heavy lines in Table 2 indicate memory locations that were written at the same time. Specifically, the game was initialized with 5 cards (memory locations 1-5) by activation a random selection of cards, where the index of each card corresponds to the Index of Table 1. After each round of play, a card is won (activated) or lost (deactivated) as indicated in Table 2, with memory locations 6 and 7 written after the first round of play and rounds 8 and 9 written at the end of the next round of play. Table 2 fills up as the play proceeds, and the current holdings may be established at any time by reading Table 2 from the beginning to the last written memory location.

TABLE 1
One embodiment of Table 502

| Index | Attribute |
|---|---|
| 1 | ace of spades |
| 2 | 2 of spades |
| 3 | 3 of spades |
| . . . | . . . |
| 52 | king of diamonds |

TABLE 2
One embodiment of Data 503

| Memory | | |
|---|---|---|
| location | Index | Flag |
| 1 | 10 | activate |
| 2 | 34 | activate |
| 3 | 8 | activate |
| 4 | 17 | activate |
| 5 | 22 | activate |
| 6 | 10 | deactivate |
| 7 | 34 | deactivate |
| 8 | 50 | activate |
| 9 | 33 | deactivate |
| . . . | . . . | . . . |
| 1000 | | |

For status games having status states with more than one attribute, the Attribute column of Table 1 is expanded to include more columns.

FIG. 6 is a flow chart 600 illustrating one embodiment method of gaming using game machine 400. A game begins by a player starting the game (Block 601), by providing power to a game system. For a single game cartridge Block 601 may be executed by providing power to game system 400, or for multiple game cartridges, by selecting a command, such as a command to start the game according to information presented on LCD 324 and input from switches 326. In one embodiment, for example, CPU 311 begins executing instructions stored in game program 501 according to flowchart 600.

Next, the initialization state of the holdings is determined (Block 602). In one embodiment of game cartridge 420 the game cartridge is manufactured with a second memory 401b that is unwritten to (with no e-card holdings), and the e-card holdings are initialized upon first use of the game cartridge. For this embodiment, the determination of Block 602 can be made by determining if any amount of the second memory 401b has been written to, for example by a previous initialization of game cartridge 420 or written to by game system 400, as described subsequently. In an alternative embodiment, initialization includes setting an initialization flag in memory 401 that indicates that initialization has been accomplished, and Block 602 tests the setting of the initialization flag.

If the holdings have been initialized then game cartridge 420 includes a table of current holdings, for example in the table of e-card holdings in the second memory 401b. The table of e-card holdings are then read (Block 605), for example by CPU 311. In one embodiment, Block 605 is performed by game program 501 reading data 503 to determine the indices of the current holdings, and then reading attributes of the current holdings from table 502 according to the indices of the current holdings.

Next, the game is then played (Block 606) using the current e-card holdings. The play of the game (Block 606) can either be a solitaire game, where a player plays against the game machine, or can be played against other players that are networked together, for example through interface 325. It is preferred that, in at least a part of the game, the outcome of the game is determined by the player's e-card holdings and that e-cards are traded as a result of play.

After a round of play the e-card holdings are updated (Block 607), for example by writing to second memory 401b. In one embodiment of the present invention, the game determines which cards of the player's holdings have been lost and which have been gained in play. The index of these cards, from table 502, and flags indicating an activation (for a gain) or deactivation (for a loss) is written to data 503. The play can then be ended (Block 608) or repeated, as indicted by the dashed line leading back to Block 605.

If the holdings have not been initialized, then a number of e-cards are selected as initial holdings (Block 603). In one embodiment Block 603 proceeds by randomly selecting a fixed number of e-cards. Initialization takes place according to game program 501 by randomly selecting a number of individual status states and setting an activation flag in data 503. Alternatively, the initialization may be one or more pre-selected e-cards, or one of a limited number of pre-selected e-cards as determined by factory programming of cartridge 420. The initial holdings are written to memory (Block 604), for example into the second memory 401b. The table of holdings is then read (Block 605) and the game proceeds as described previously.

In addition to winning and losing e-cards as a result of game play, game cartridge 420 may also provide for the trading of cards between different players outside of the confines of one-on-one play (that is a straight trade) or by exchanging money by an electronic purchase through the Internet, for example.

Game cartridges of the present invention, including but not limited to game cartridge 420, contain holdings, such as e-cards holdings, that are unique to each card. That is, although it is possible that two game cartridges are identical it is extremely unlikely. Each game cartridge thus will have a value to different players of the game as a result of the current holdings stored in the cartridge. In one embodiment of the present invention, game cartridges of the present invention are traded among different player's outside of the gaming environment, either for other game cartridges, for money, or for other goods. Thus, for example, a player having one game cartridge having highly valued e-cards may trade the cartridge with another player for two game cartridges having two less highly valued cartridges, or for one less highly valued cartridge and some amount of money.

In addition to the stored holdings of the game cartridge, the memory available for storing holdings may be limited, providing additional value to the cartridge or as the basis for providing cartridge-related services. Specifically, for example, a write-once memory has a limited amount of memory that can be written to. The amount of available memory may be taken into account in determining the value of the cartridges. In addition, the cartridge manufacturer may provide a service to exchange the holdings of a fully used cartridge into the initialization of a new game cartridge.

Note that as used herein, a game cartridge for a game machine is not limited to the architecture described above that uses electronic memory. Alternate embodiments may use optical memory, e.g., a CD or DVD or a non-rotating optical medium for some or all of what would be stored in the type of game cartridge that uses only electronic memory described in the embodiments above. Furthermore, the term “game cartridge: may collectively refer to a part that uses electronic memory, and another part that uses some other form of storage, e.g., an optical storage medium.

One embodiment of each of the methods described herein is in the form of a computer program that executes on a processing system, e.g., a one or more processors and memories that are part of an embedded system such as a game system. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, a electronic memory game machine cartridge, or a game machine cartridge that uses an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

It should further be appreciated that although every aspect of the coding has not been discussed in detail, the invention is not limited to a specific coding method. Furthermore, the invention is not limited to any one type of network architecture and method of encapsulation, and thus may be utilized in conjunction with one or a combination of other network architectures/protocols.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A game cartridge for a game machine, said game cartridge and the game machine forming a game system to provide an electronic game for playing by a player, said electronic game having a player status for said player, said game cartridge comprising:
a memory to store information related to the player status, wherein said memory is a write-once memory.

2. The game cartridge of claim 1, wherein said write-once memory is a one-time-programmable memory.

3. The game cartridge of claim 1, wherein said information related to the player status is initialized by the game system.

4. The game cartridge of claim 3, wherein said information related to the player status is initialized upon first use of said game cartridge.

5. The game cartridge of claim 1, wherein the game machine includes a processing system having at least one processor, and wherein said memory is a first memory, the game cartridge further comprising:
a second memory to store computer-readable code segments to instruct processing system of the game system to implement the electronic game.

6. The game cartridge of claim 5, wherein said second memory is a write-once memory.

7. The game cartridge of claim 6, wherein said second memory is aone-time-programmable memory.

8. The game cartridge of claim 5, wherein said game is a collectable card game.

9. The game cartridge of claim 8, wherein said second memory stores a data structure to store a set of collectable card attributes, and wherein said information related to the player status includes a player's holding of collectable cards.

10. The game cartridge of claim 9, wherein said collectable card game is a POKÉMON™ game, a Magic the Gathering game, a Yu-Gi-Oh game, a Vs System game, a Wizards of the Coast game, or a game played with one or more decks of playing cards.

11. The game cartridge of claim 1, wherein the player status includes a card value, a character, a figure, a weapon, a strength, a game piece or figurine, or a power.

12. A method of accounting for a player status of a player of an electronic game, the game being playable on a game system including a game cartridge and a game machine, said game cartridge having memory including a write-once memory, said method comprising:
storing data related to a player status in said write-once memory.

13. The method of claim 12, wherein the game is a collectable card game, wherein said memory includes a data structure including a table of collectable card attributes, and wherein said data related to the player status includes a player's holdings of collectable cards.

14. The method of claim 13, wherein said collectable card game is a POKÉMON™ game, a Magic the Gathering game, a Yu-Gi-Oh game, a Vs System game, a Wizards of the Coast game, or a game played with one or more decks of playing cards.

15. The method of claim 12, wherein said game is a strategy game or a role-playing game.

16. The method of claim 12, further comprising:
initializing the player status.

17. The method of claim 16, wherein said initializing initializes upon first use of the game cartridge.

18. The method of claim 12, wherein the player plays against the game system.

19. The method of claim 12, wherein the player plays against one or more other players.

20. The method of claim 12, wherein the electronic game is played against one or more other players on another game machine in communication with the game machine.

21. The method of claim 12, wherein said game cartridge includes a memory for storing computer-readable code segments including game machine instructions for playing the electronic game.

22. The method of claim 12, wherein said write-once memory is a one-time-programmable memory.

23. A game cartridge including a medium carrying one or more computer readable code segments to instruct a processor to implement a method of accounting for a player status of a player of an electronic game, the game being playable on a game system including a game cartridge and a game machine, said game cartridge having memory including a write-once memory, said method comprising:
storing data related to a player status in said write-once memory.

24. The game cartridge of claim 23, wherein the game is a collectable card game, wherein said memory includes a data structure including a table of collectable card attributes, and wherein said data related to the player status includes a player's holdings of collectable cards.

25. The game cartridge of claim 24, wherein said collectable card game is a POKÉMON™ game, a Magic the Gathering game, a Yu-Gi-Oh game, a Vs System game, a Wizards of the Coast game, or a game played with one or more decks of playing cards.

26. The game cartridge of claim 23, wherein the player status includes a card value, a character, a figure, a weapon, a strength, a game piece or figurine, or a power.

27. The game cartridge of claim 23, further comprises:
initializing the player status.

28. The game cartridge of claim 27, wherein said initializing initializes upon first use of the game cartridge.

29. The game cartridge of claim 23, wherein the player plays against the game system.

30. The game cartridge of claim 23, wherein the player plays against one or more other players.

31. The game cartridge of claim 23, wherein the electronic game is played against one or more other players on another game machine in communication with the game machine.

32. The game cartridge of claim 23, wherein said game cartridge includes a memory for storing computer-readable code segments including game machine instructions for playing the electronic game.

33. The game cartridge of claim 23, wherein said write-once memory is a one-time-programmable memory.

34. A game cartridge including a medium carrying one or more computer readable code segments to instruct a processor to carry out a method of implementing an electronic collectable card game on a game cartridge having a memory, said method comprising:
presenting a gaming environment to the player for playing the game;
reading a player status from a write-once memory of the game cartridge;
determining changes in the player status based on the play of the game; and
writing changes to the player status to the write-once memory of the game cartridge.

35. The game cartridge of claim 34, further comprising:
initializing the player status upon first use of the game cartridge.

36. The game cartridge of claim 34, wherein said game is a POKÉMON™ game.

37. The method comprising:
trading one or more game cartridges between game cartridge owners, where the trade is based, at least on part, by a status related to the previous playing of each of the traded game cartridges.

38. The method of claim 37, wherein at least one of said one or more said game cartridges is a POKÉMON™ game cartridge.

39. The game cartridge of claim 1, wherein said game cartridge is an optical disk, and wherein said write-once memory is a once-writeable part of the optical disk.

40. The Method of claim 12, wherein said game cartridge is an optical disk, and wherein said write-once memory is a once-writeable part of the optical disk.
